(19) United States
(12) Patent Application Publication
(10) Pub. No.: US 2009/0120141 A1
(43) Pub. Date: May 14, 2009

(54) DUAL CHANGEABLE COMBINATION LOCK

(76) Inventor: Chien-Yung Huang, Banchiao City (TW)

Correspondence Address: PRO-TECHTOR INTERNATIONAL SERVICES, 20775 NORADA CT., SARATOGA, CA, 95070, US

(21) Appl. No.: 12/266,555

(22) Filed: Nov. 7, 2008

(30) Foreign Application Priority Data
Nov. 9, 2007 (TW) 096218995

(51) Int. Cl. E05B 37/00

(52) U.S. Cl. 70/24

(57) ABSTRACT

A dual changeable combination lock comprises a housing in which are disposed internal and external toothed wheels each engaging with or disengaging from each dial, wherein the internal toothed wheels can control the shackle and the external toothed wheels can control the switch button. Besides providing the combination changing function of a common combination lock, the above lock can provide another set of separately and independently set changeable numbers by the interaction between the button and the external toothed wheels.

### BACKGROUND OF THE INVENTION

(a) Field of the Invention

The present invention relates to a dual changeable combination lock, and more particularly to a combination lock that has the dual changeable functions.

(b) Description of the Prior Art

A conventional combination lock is based on driving the internal toothed wheels by the dials, as shown in U.S. Pat. No. 4,733,548, wherein the internal toothed wheels can control the movement of the shackle, and the lock opening combination of the dials can be changed by the engagement and disengagement of the internal toothed wheels with the dials.

However, the conventional combination lock has only one set of lock opening combination and cannot provide another set of lock opening is combination. Therefore, there is a need for improvement.

### SUMMARY OF THE INVENTION

The primary object of the present invention is to provide a dual changeable combination lock in which are disposed internal toothed wheels and external toothed wheels each engaging with each dial, wherein the internal toothed wheels can control the movement of the shackle, and the external toothed wheels can control the motion of the switch button, and two sets of separately and independently set lock opening combinations are provided by the engagement and disengagement of the internal and external toothed wheels with the dials.

### BRIEF DESCRIPTION OF THE DRAWINGS

FIG. 1 is a sectional view of a first embodiment of the present invention in a locking position.

FIG. 1-1 is atop view of FIG. 1.

FIG. 1-2 is a top view of a first embodiment of the present invention when reaching a first correct opening combination.

FIG. 1-3 is a sectional view of a first embodiment of the present invention when reaching a first correct opening combination and pulling out the shackle.

FIG. 2 is a sectional view of a first embodiment of the present invention when reaching a second correct opening combination.

FIG. 2-1 is a top view of FIG. 2.

FIG. 3 is a schematic sectional view of a first embodiment of the present invention before changing the combination numbers.

FIG. 3-1 is a sectional view of a first embodiment of the present invention when a new first correct opening combination can be set.

FIG. 4 is a schematic sectional view of a first embodiment of the present invention when changing to a new second open combination in a second manner.

FIG. 5 is a front view of a second embodiment of the present invention in a full locking position.

FIG. 6 is a sectional view of a second embodiment of the present invention when reaching a first correct opening combination.

FIG. 6-1 is a top view of FIG. 6.

FIG. 6-2 is a side view of FIG. 6.

FIG. 7 is a sectional view of a second embodiment of the present invention when locking a first opening combination and opening a second opening combination.

FIG. 7-1 is a top view of FIG. 7.

FIG. 7-2 is a side view of FIG. 7. 5

FIG. 7-3 is a side view of FIG. 7 when opening the box cover.

FIG. 8 is a sectional view of a third embodiment of the present invention in a full locking position.

FIG. 9 is a sectional view of a third embodiment of the present invention when reaching a first correct opening combination.

FIG. 10 is a sectional view of a third embodiment of the present invention when a new first opening combination can be set.

FIG. 11 is a sectional view of a third embodiment of the present invention when reaching a second correct opening combination.

FIG. 12 is a sectional view of a third embodiment of the present invention is when changing to a new second opening combination of a second correct opening combination.

### DETAILED DESCRIPTION OF THE PREFERRED EMBODIMENTS

A combination lock according to present invention comprises: a housing 10 and a plurality of dials 40, all the dials 40 being arranged in a single row, each of the dials 40 being capable of rotating with respect to the housing 10, the dials 40 having two opening combinations, the two opening combinations being able to be mutually independent and changed into new opening combinations respectively, and the two new opening combinations also being able to be mutually independent.

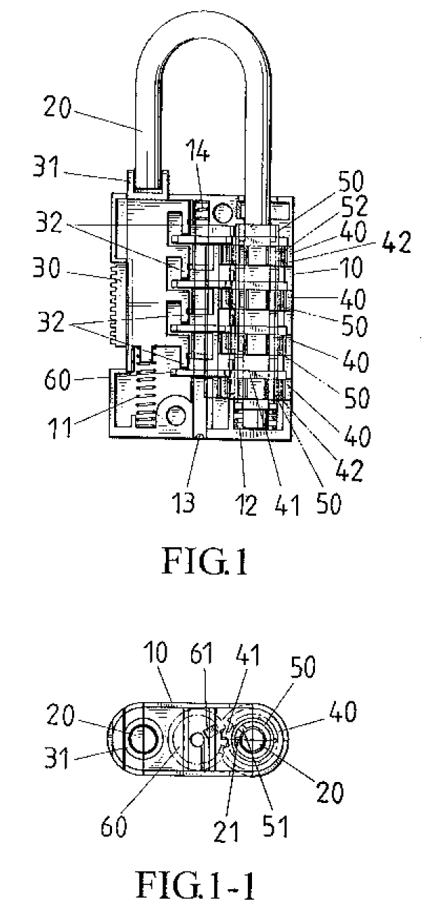

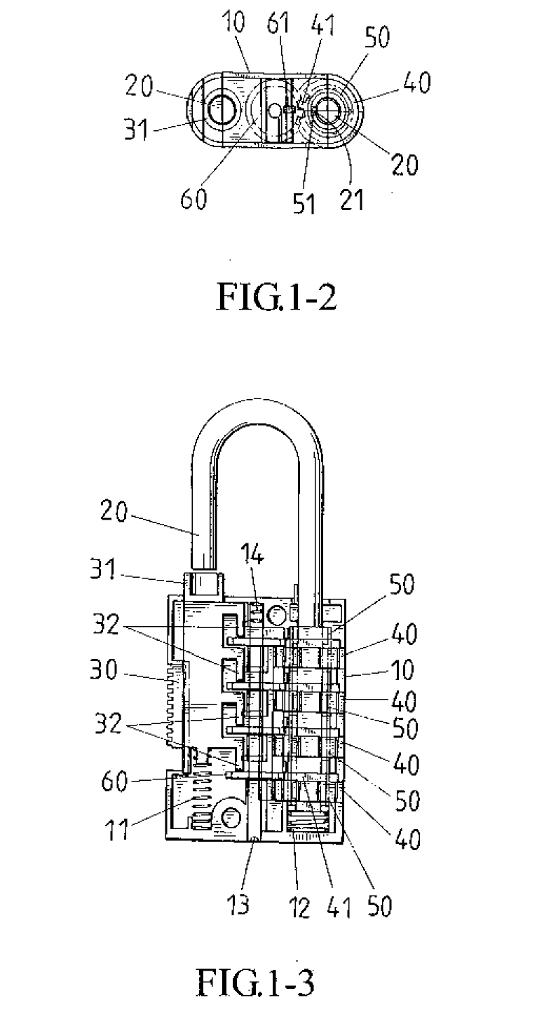

In a first embodiment of the present invention: Referring to FIGS. 1 and 1-1, a combination lock according to the present invention in a locking position comprises: a housing 10, a shackle 20, a button 30, a plurality of dials 40, a plurality of internal toothed wheels 50 and a plurality of external toothed wheels 60, wherein the internal teeth 42 of the dials 40 mutually engage with the external teeth 52 of the internal toothed wheels 50, the external teeth 41 mutually engage with the external toothed wheels 60, the shackle 20 has thereon protrusions 21 which is not aligned with the notches 51 of the internal toothed wheels 50, and the button 30 has thereon a sleeve 31 for sleeving on the shackle 20 and has therein insert blocks 32 for passing through the notches 61 of the external toothed wheels 60;

The sleeve 31 on the button 30 is sleeved on the shackle 20 and the insert blocks 32 within the button 30 are not aligned with the notches 61 of is the external toothed wheels 60 so that the button 30 cannot be pushed downwardly and the lock is locked.

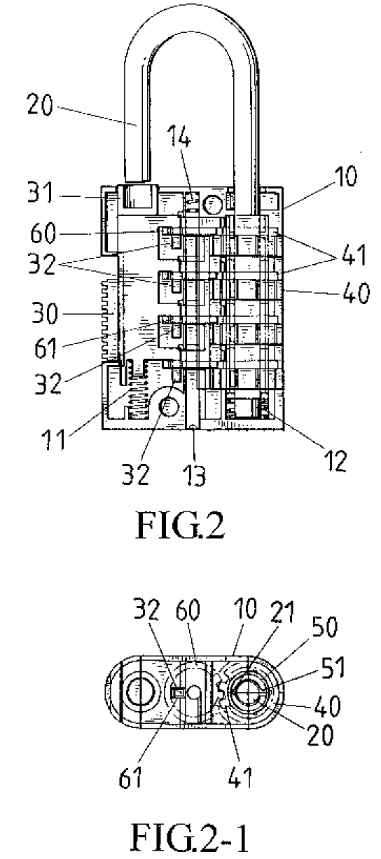

Referring to FIG. 1-2, the dials 40 reach a first correct opening combination, and the protrusions 21 of the shackle 20 are aligned with the notches 51 of the internal toothed wheels 50. Referring to FIG. 1-3, the shackle 20 can be pulled out of the housing 10.

Referring to FIGS. 2 and 2-1, when the lock reaches a second correct opening combination, the notches 61 of the external toothed wheels 60 are aligned with the insert blocks 32 of the button 30. At this time, the button 30 and the sleeve 31 are pushed downwardly, and the insert blocks 32 of the button 30 can pass through the notches 61 of the external toothed wheels 60 and compress the spring 11 at their lower ends so that the shackle 20 disengage from the sleeve 31 of the button 30 and the lock is opened.

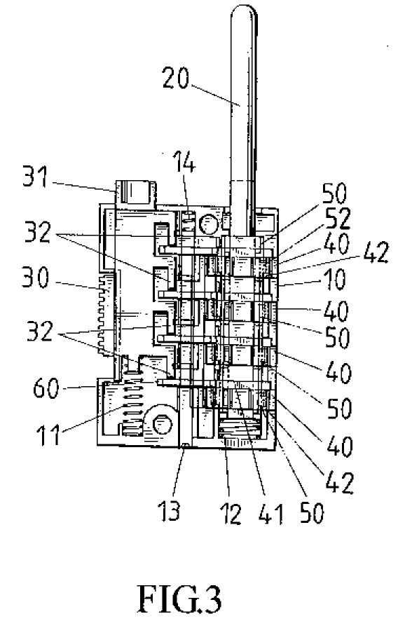

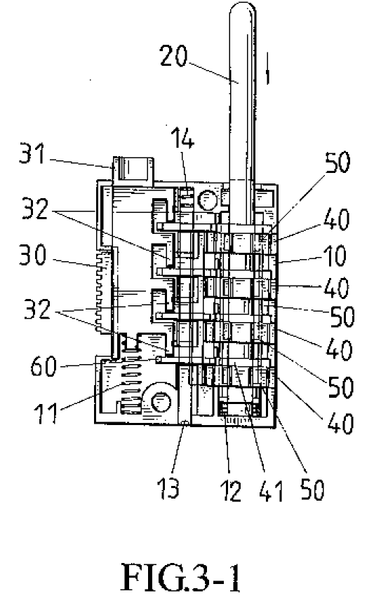

Referring to FIGS. 3 and 3-1, the first opening combination of the present invention is changed into a new opening combination. The locked shackle 20 in FIG. 1 is pulled out and then rotates at 90°. The shackle 20 is pressed downwardly and the protrusions 21 of the shackle 20 can press the internal toothed wheels 50 to move downwardly and contract the spring 12 so that the external teeth 52 of the internal toothed wheels 50 disengage from the internal teeth 42 of the dials 40 and then the dials 40 are rotated to change to a new open combination. When the force applied to the shackle 20 is cancelled, the spring 12 will push the internal toothed wheels 50 upwardly to engage with the dials 40, thus obtaining a new first opening combination.

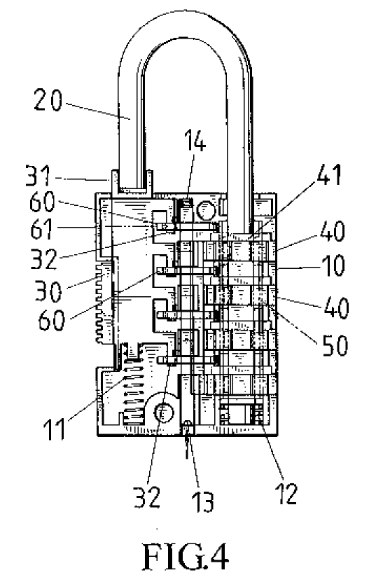

Referring to FIG. 4, the second opening combination of the present invention is changed into a new opening combination. When the dials 40 show the opening combination, a sharp object is pushing the changeable switch 13 to move the external toothed wheels 60 upwardly and compress the return spring 14 thereabove so that the external toothed wheels 60 disengage from the external teeth 41 of the dials 40. Because the notches 61 of the external toothed wheels 60 are locked by the insert blocks 32 of the button 30, the external toothed wheels cannot rotate. At this time, the dials 40 are rotated to change the combination numbers. When the sharp object that applies force to the changeable switch 13 is removed, the return spring 14 will push the external toothed wheels 60 downwardly to engage with the external teeth 41 of the dials 40, thus obtaining a new second opening combination.

In summarization of the foregoing description, the new first opening combination and the new second opening combination can be mutually independent. The internal toothed wheels 50 and the external toothed wheels 60 each can disengage from the dials 40 so as to change the respective new opening combinations.

In a second embodiment of the present invention: Referring to FIG. 5, the housing 10 of the combination lock according to the present invention is provided with a box 70. The shackle 20 extends into the housing 10 into a locking state. The button 30 beside the box 70 is located at the upper position and the box 70 is in a locking state.

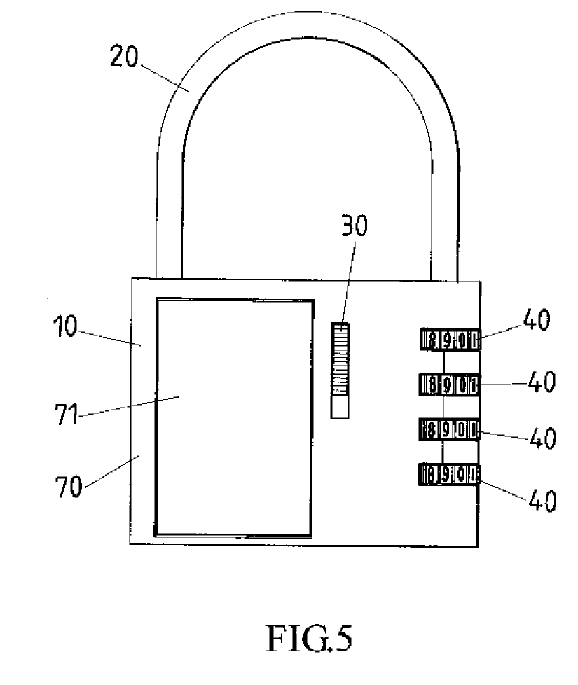

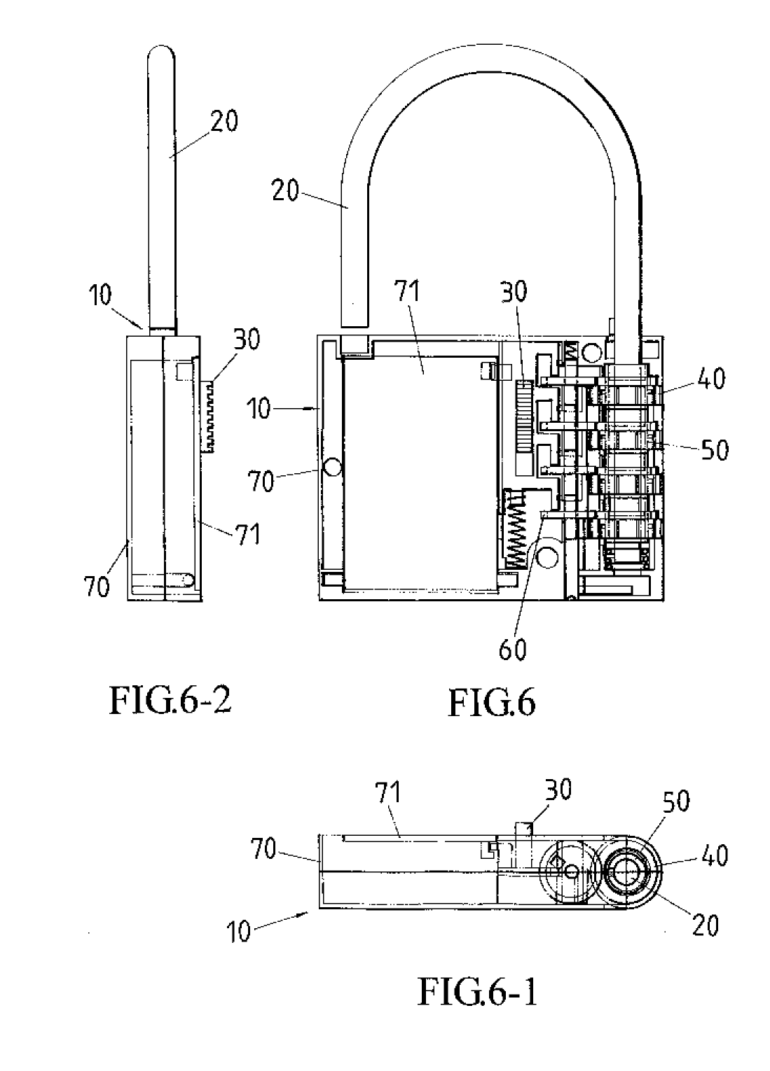

Referring to FIGS. 6 and 6-1 and 6-2, the dials 40 reach a first correct opening combination, and the shackle 20 can be pulled out to open the lock.

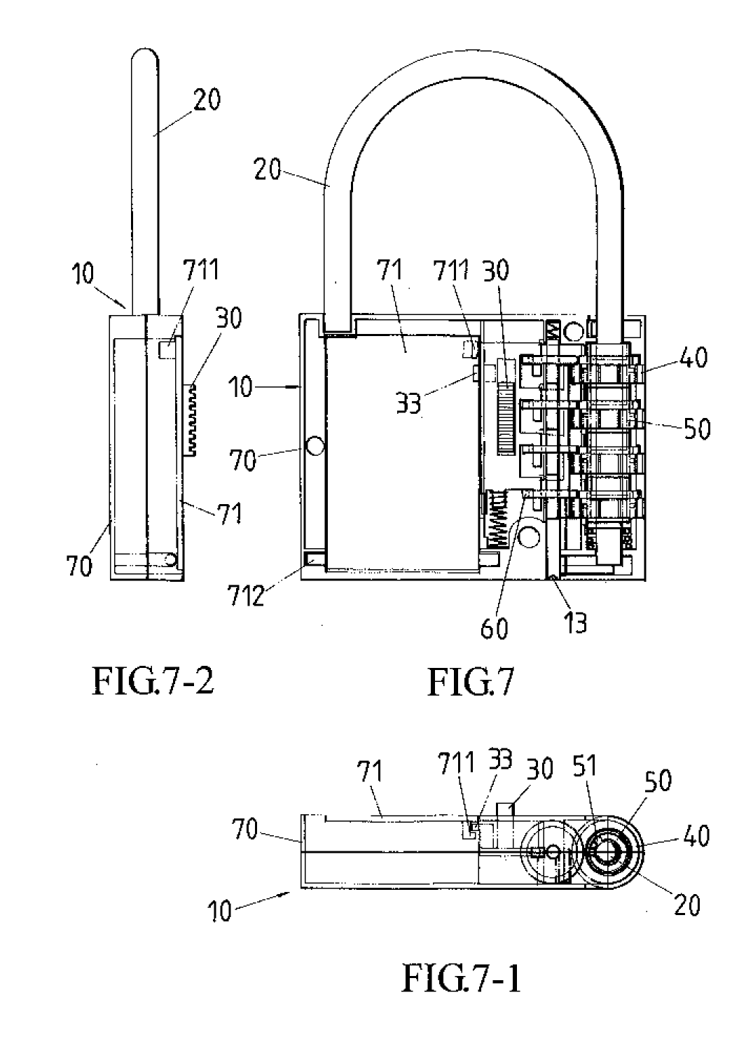

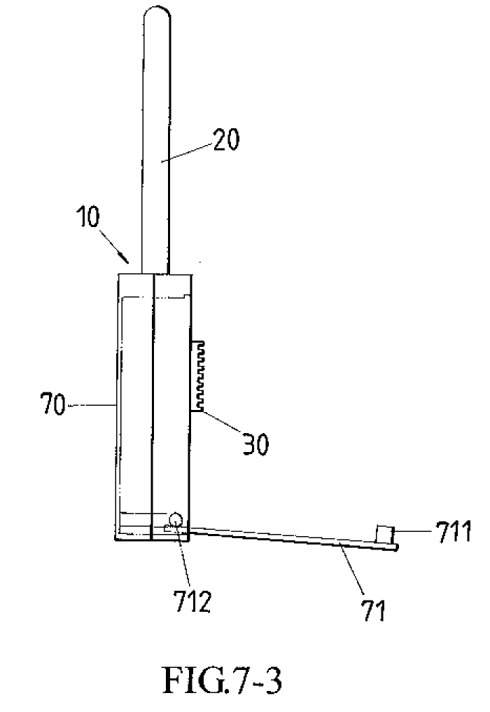

Referring to FIGS. 7 and 7-1 and 7-2 and 7-3, when the shackle 20 is in a locking state, the button 30 is pushed downwardly and the snap fitting 33 of the button 30 is not buckled with the buckling block 711 on the box cover 71 of the box 70 so that the box cover 71 at the front edge of the box 70 can be opened around the axis 712 as a center of the bottom to receive keys or belongings.

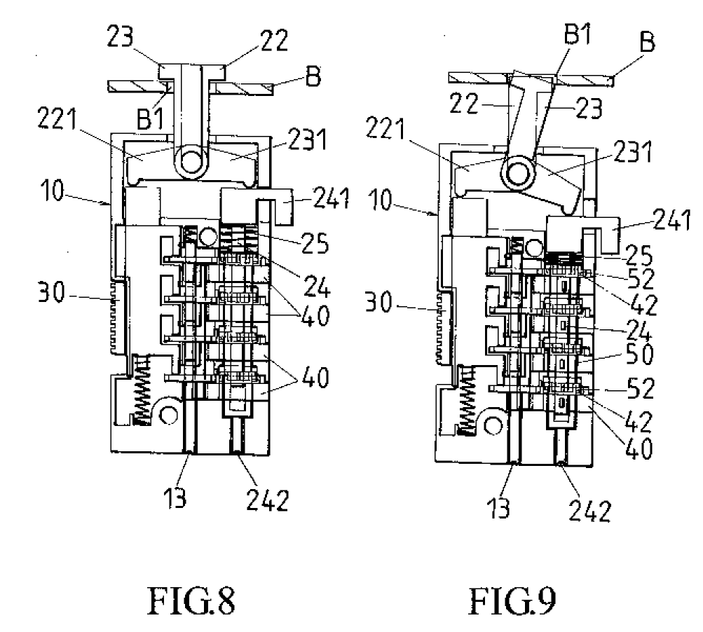

In a third embodiment of the present invention: Referring to FIG. 8, a lock for a computer has two L-shaped shackles 22, 23 locking the lock hole B1 of a to be locked article B, and the two shackles 22, 23 are shaft coupled at their lower ends to pressing blocks 221, 231 respectively, wherein one pressing block 221 is propped at its lower portion against the back up plate 241 on the upper portion of the lock rod 24, the other pressing block 231 is propped against the upper portion of the switch button 30, a changeable switch 242 is provided at the bottom of the housing 10.

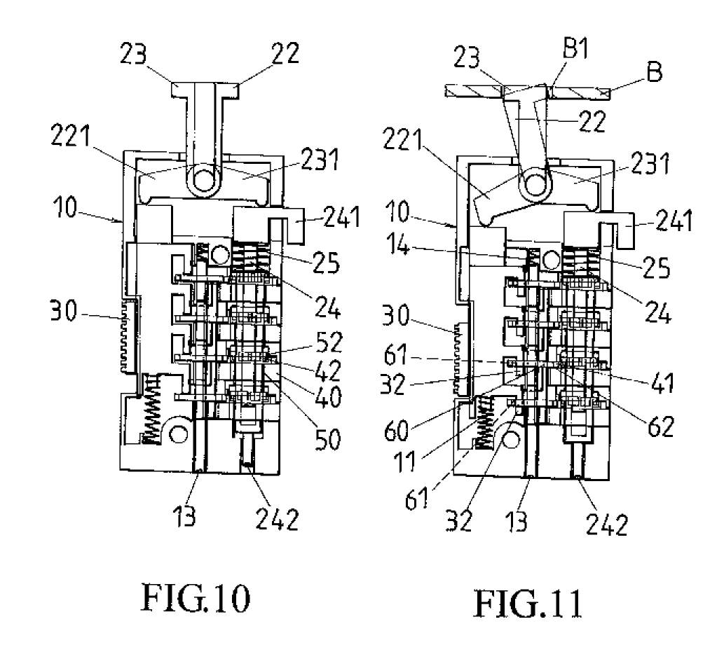

Referring to FIG. 9, the dials 40 use a first opening combination to open the lock, and the pressing block 231 is pressed downwardly to compress the spring 25 and move the lock rod 24 downwardly so that the shackle 23 can be tilted to disengage from the lock hole B1 of the article B and then the lock is opened. Referring to FIG. 10, the dials 40 show the first opening combination. If it is desired to change the combination numbers, a sharp object is pushing the changeable switch 242 to drive the internal toothed wheels 50 to move upwardly and the external teeth 52 of the internal toothed wheels 50 disengage from the internal teeth 42 of the dials 40. Accordingly, the dials 40 can be rotated to change to a new combination numbers.

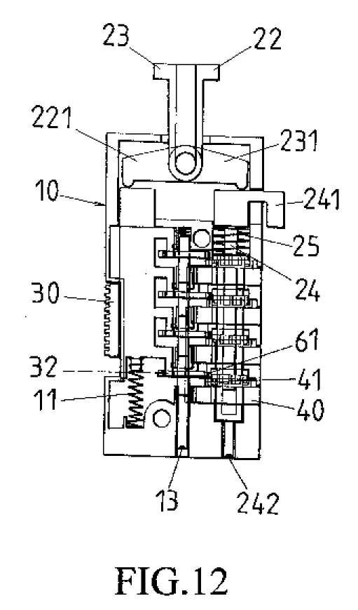

Referring to FIG. 11, the dials 40 use a second opening combination to open the lock, and the pressing block 221 presses down on the button 30 and compresses the spring 11 so that the shackle 22 can be tilted to disengage from the lock hole B1 of the article B and then the lock is opened. Referring to FIG. 12, the dials 40 are at the second opening combination. If it is desired to change the combination numbers, a sharp object is pushing the changeable switch 13 to move the external toothed wheels 60 upwardly and compress the return spring 14 thereabove so that the external toothed wheels 60 disengage from the external teeth 41 of the dials 40. Because the notches 61 of the external toothed wheels 60 are locked by the insert blocks 32 of the button 30, the external toothed wheels cannot rotate. Accordingly, the dials 40 can be rotated to change to a new combination numbers.

As is apparent from the foregoing, the present invention provides a dual changeable combination lock, in the housing of which are disposed internal and external toothed wheels each capable of engaging with or disengaging from each dial to provide two sets of changeable numbers. The above two sets of numbers can be separately set and mutually independent, so it is impossible to predict another set of combination from one set of combination. Various structures can be derived from the button to be adapted to different functions.

What is claimed:

1. A dual changeable combination lock, comprising a housing and a plurality of dials, all the dials being arranged in a single row, each of the dials rotating with respect to the housing, the dials having a first
opening combination and a second opening combination that are changed into a new first opening combination and a new second opening combination respectively, and the two new opening combinations being mutually independent.

2. A dual changeable combination lock according to claim 1, wherein said combination lock comprises a housing, a shackle, a button, a plurality of dials, a plurality of internal toothed wheels and a plurality of external toothed wheels, wherein the internal and external toothed wheels each is able to engage with or disengage from each dial, and the internal toothed wheels control the shackle and the external toothed wheels control the button to provide two sets of separately and independently set changeable numbers.

3. A dual changeable combination lock according to claim 1, wherein said dials have the internal teeth that mutually engage with the external teeth of the internal toothed wheels.

4. A dual changeable combination lock according to claim 1, wherein said housing has a changeable switch for pushing a sharp object to push into so that the internal toothed wheels disengage from the dials and the dials are rotated to change the combination numbers.

5. A dual changeable combination lock according to claim 1, wherein said dials have the external teeth that mutually engage with the external toothed wheels.

6. A dual changeable combination lock according to claim 1, wherein said housing has another changeable switch for a sharp object to push inward so that the external toothed wheels are separated from the dials and the dials are rotated to change the combination numbers.

7. A dual changeable combination lock according to claim 2, wherein said external toothed wheels have notches and the button has insert blocks, and when a correct lock opening combination is reached, the insert blocks are inserted into the notches.

8. A dual changeable combination lock according to claim 2, wherein said button has thereon a sleeve for sleeving on the shackle so as to lock the lock.

9. A dual changeable combination lock according to claim 1, wherein said housing is provided therein with a return spring to allow the external toothed wheels to engage with the dials again after changing the combination numbers.

10. A dual changeable combination lock according to claim 1, wherein said housing is provided with a box and an openable box cover is provided in front of the box.

11. A dual changeable combination lock according to claim 1, wherein said housing is provided with two L-shaped shackles that are locked in the lock hole of an article to be locked.

12. A dual changeable combination lock according to claim 11, wherein said two shackles are shaft coupled at their lower ends to pressing blocks respectively.
